(19) United States
(12) Patent Application Publication
(10) Pub. No.: US 2022/0058937 A1
(43) Pub. Date: Feb. 24, 2022

(54) SYSTEM AND METHOD FOR THRUPASS SYSTEM FOR MULTI-SENSOR GATEWAY SYSTEM

(71) Applicant: PatriotOne Technologies, Toronto (CA)

(72) Inventors: Nevine DEMITRI, Toronto (CA); Paul RICE, Formby (GB); Farhan NAEEM, Mississauga (CA); Jeanault LASNIER, Toronto (CA)

(73) Assignee: PatriotOne Technologies, Toronto (CA)

(21) Appl. No.: 17/407,878

(22) Filed: Aug. 20, 2021

Related U.S. Application Data
(60) Provisional application No. 63/068,366, filed on Aug. 20, 2020.

(51) Int. Cl. G08B 25/00; G01V 15/00; G06K 7/10

(52) U.S. Cl. CPC G08B 25/008; G01V 15/00; G06K 7/10346; G06K 7/10297; G06K 7/10366

(57) ABSTRACT

A system and method that allows law enforcement agents and undercover officers to pass through a gateway screening system without setting off an alarm—provided that these personnel are “known” to the system. The system utilizes wireless technologies (i.e., RFID/NFC) that integrates with existing security screening system. The system reads a wireless tag (i.e., RFID/NFC) on his/her weapon and personal ID fob and authenticates them through a database. If the information is authenticated and verified, the system alarm is overridden and the officer can pass through. The Thrupass system can also be used to pass known larger items that would usually alert, such as trays or dollies in a hospital setting.

### CROSS REFERENCE TO RELATED APPLICATIONS

The application claims priority and the benefit of U.S. Provisional Patent Application Ser. No. 63/068,366, entitled “SYSTEM AND METHOD FOR THRUPASS SYSTEM FOR MULTI-SENSOR GATEWAY SYSTEM”, filed on Aug. 20, 2020, the disclosure of which is incorporated herein by reference in its entirety.

### BACKGROUND

The embodiments described herein relate to security and surveillance, in particular, technologies related to video recognition threat detection.

Security screening systems are installed in offices, commercial buildings, event arenas, airports and other buildings to screen for potential threats (i.e., knives, guns, weapons, etc.). One concern is how do “known” security personnel pass through a security screening system without triggering the alarm of the system. This is more important if the security officer is undercover, as they would not want to have their cover blown.

Currently, officers and other law enforcement agents (LEAs) walk through a metal detector and would require to divest their weaponry (i.e., remove their weapons to be scanned). Security systems are typically deployed in airport and other environments where the deployment is more controlled and all items need to pass through a CT bag scanner. The process for security systems in public spaces is less clear and would likely vary depending on the local user protocols.

There is a desire to implement a system and method for undercover or law enforcement agents to pass through a screening system without setting off an alarm or without having to remove their weapon.

### SUMMARY

A system and method that allows law enforcement agents and undercover officers to pass through a gateway screening system without setting off an alarm—provided that these personnel are “known” to the system. The system utilizes wireless technologies (i.e., RFID/NFC) that integrates with existing security screening system. The system reads a wireless tag (i.e., RFID/NFC) on his/her weapon and personal ID fob and authenticates them through a database. If the information is authenticated and verified, the system alarm is overridden and the officer can pass through. The Thrupass system can also be used to pass known larger items that would usually alert, such as trays or dollies in a hospital setting.

### BRIEF DESCRIPTION OF THE DRAWINGS

FIG. 1 is a hardware block diagram of an exemplary RFID system.

FIG. 2 is a diagram illustrating sample passive RFID tags.

FIG. 3 is a diagram illustrating a sample active RFID tag.

FIG. 4 is a hardware block diagram of the Thrupass system.

FIG. 5 is a software block diagram illustrating software components for the Thrupass system.

### DETAILED DESCRIPTION

RFID uses electromagnetic fields to automatically identify and track tags attached to objects. A basic RFID system consists of:
1. RFID tag (Passive/Active) attached to an asset to be tracked;
2. RFID reader (possibly with an integrated antenna) which can also write tags; and
3. Control system which can be a PC/laptop or an embedded device.

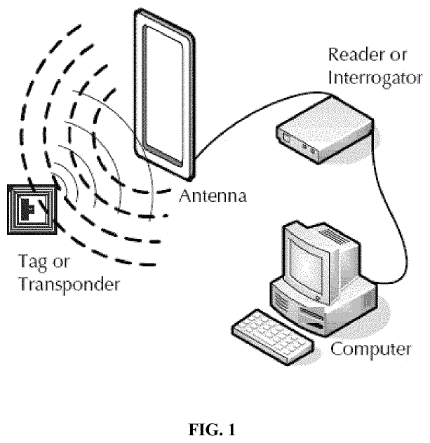

FIG. 1 is a hardware block diagram of an exemplary RFID system. According to FIG. 1, an RFID tag consists of a tiny radio transponder; a radio receiver and transmitter. When triggered by an RF pulse from a nearby RFID reader device, the tag transmits digital data, usually an identifying number, back to the reader. This number can be used to uniquely identify assets. Unlike a barcode, the tag doesn't need to be within the line of sight of the reader, however the orientation of the tag and the antenna polarization of the RFID reader needs to be taken into consideration for maximum efficiency and read performance.

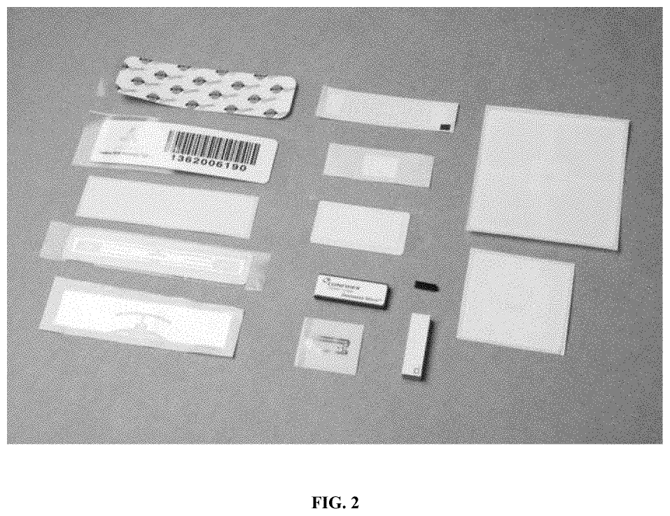

There are two types of RFID tags in general—a passive RFID system and an active RFID system. In a Passive RFID system, the tags do not use a battery; instead, they receive their energy to run from the reader. The reader emits an energy field of a few feet, providing the energy for any tag in the vicinity. The tag gathers the electromagnetic energy from the card reader, powers up, and responds with its identification information. Passive tags have the benefit of being able to be read at a fast rate (100 or more times a second). They are extremely thin (allowing them to be placed between layers of paper) and are extremely cheap. The tags also vary in frequency of operation, manufacturing material and type of asset that it can be used such as metal, fabric and plastic materials. FIG. 2 is a diagram illustrating sample passive RFID tags.

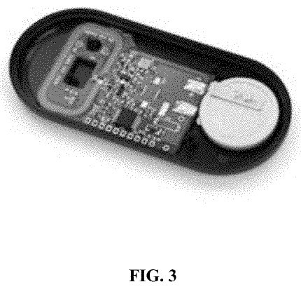

Active RFID systems include tags that have their own internal power supply for increased range. Active tags possess a battery and usually have larger circuit components. After a preset amount of time the tag emits a RF ‘chirp’. A reader in the vicinity can listen for and hear this chirp because an active tag can be read over much larger distances than passive tags (tens of feet). Downsides to active tags include greater bulk (because of the battery), limited life span (tag is dead when the battery is exhausted), increased cost per tag, and varying report rates. FIG. 3 is a diagram illustrating a sample active RFID tag.

In a preferred embodiment, a multi-sensor covert threat detection system is disclosed. This covert threat detection system utilizes software, artificial intelligence and integrated layers of diverse sensor technologies (i.e., cameras, etc.) to deter, detect and defend against active threats (i.e., detection of guns, knives or fights) before these threat events occur.

In a preferred embodiment, a security officer or law enforcement agent approaches the system and walks normally through the screening gateway. The system reads a wireless tag (i.e., RFID/NFC) on his/her weapon and personal ID fob and authenticates them through a database. If the information is authenticated and verified, the system alarm is overridden and the officer can pass through.

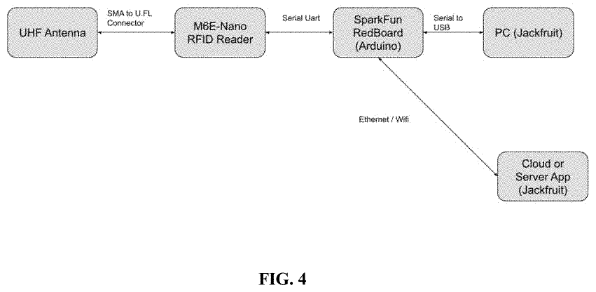

FIG. 4 is a hardware block diagram of the Thrupass system. According to FIG. 4, the ThruPass system consists of the following hardware components.
1. RFID Reader-M6E Nano
The RFID reader identified to be used as proof of concept is developed by SparkFun and contains ThingMagic M6E Nano UHF reader chipset. This particular reader board can connect directly to an Arduino compatible board or any other microcontroller board that has a serial interface. The M6E Nano chipset is capable of reading/writing EPC Global GEN2 tags. The board has an adjustable power output of 0 dBm to 27 dBm. Connecting an external antenna increases the read range to ^{˜}10 ft. The board also has an internal antenna that can perform read/write operations up to 1 ft.
2. SparkFun RedBoard (Arduino UNO)
In order to control the RFID reader a variant of Arduino, SparkFun RedBoard is used. The board can be programmed using Arduino IDE. The RFID reader connects to the Arduino board via stackable headers and communicates over serial interface.
3. Antenna
The M6E-Nano RFID reader board has two options for antenna connection. The internal antenna can be used for short distance read/write applications typically at a distance of a few centimeters to 1 ft. In order to read/write at large distance an external antenna should be used. For our first PoC we are using the UHF RFID Antenna (TNC) from SparkFun. This particular antenna has 6 dBi gain and linear vertical polarization. The antenna can operate between 860-960 MHz frequency range.
4. RFID Tag
RFID tags are an integral part of an RFID system. There are several types of RFID tags available and differ based on the application requirements, operating frequency and communication protocol. RFID tags can be classified into Active and Passive tags. For our PoC system we are evaluating passive tags because of cost, ease of installation and form factor. Active tags require an energy source such as a battery to power it up and are bulky as well.

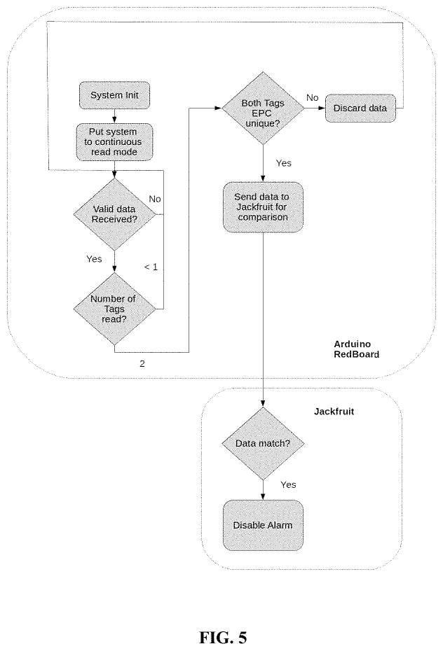

FIG. 5 is a software block diagram illustrating software components for the Thrupass system. According to FIG. 5, there exists two main modules—the Arduino RedBoard module and a custom acquisition software module.

According to FIG. 5, the system is initiated and is put in a continuous read mode. The system determines whether valid data is received. If no valid data is received, the data Is discarded.

If valid data is received, the system checks for the number of tags read. If the number of tags is one or less, than the data is also discarded. However, if there are more than two or more tags, the system then verifies whether both tags are electronic product code (EPC) EPC unique. If the EPA is not unique, the data is also discarded.

If the EPC tags are indeed unique, the data is sent to the software module for comparison. At the software module, the system then determines whether the data matches with what is in the system. If there is a match, the alarm is disabled. However, if there is no match, then the system would operate as normal and would alarm if a threat is present.

A user case for the operation of this system is as follows:
1. RFID reader is set to continuous read mode to detect nearby tags operating at UHF (Ultra High Frequency).
2. When a security officer approaches the multi-sensor gateway (MSG), the weapon RFID tag and officer's personal tag is read.
3. The tag IDs are then sent to the processing system (PC/Cloud/Local Server) where the tag IDs are compared with entries stored on the database.
4. In case both weapon tag and officer tag match, the MSG alarm system is overridden and the system does not cause an alarm.

The tag comparison depends on the use case. For example, a client site might want the security officer to use only the weapon the officer was assigned. In this case if the officer tries to pass with an authorized tagged weapon but not assigned to him the system will set up an alarm. Likewise, there can be many different use cases based on the client's requirements.

A key feature of the proposed embodiment is to provide 2-factor authentication to link a security personnel's weapon with the individual security operative and allow the individual to pass through a screening system without setting off the alarm.

Both the security operative's weapon and ID must be matched for the sensor output to be bypassed. This prevents, for example, if the weapon is being carried by an unauthorized person.

In one embodiment of the Thrupass system, the antennas are mounted to face the subject as they approach the system. For a bi-directional gateway system there would be two antennas required. They would be positioned on the same gateway pillar, on opposite sides. The performance of the Thrupass system is sensitive to the antenna position relative to the weapon. Furthermore, an antenna positioned at waist height allows the most body coverage, but may not detect signals from weapons carried at the shoulder and ankle. The officer would need to follow a SOP (Standard Operating Procedure) to increase the detection rate of the Thrupass system. For example, if the antenna is always on the RHS and positioned at waist height, then the officer would need to carry their weapon on their RHS, around their midriff.

In another embodiment, there are four antennas used and located in the same pillar. Two antennas would be located on the front face and two on the back face as the subject approaches the system. On each side, the antennas would be positioned at chest height and knee height respectively. The officer would still follow a SOP but would be able to carry the weapon in more locations in the vertical plane, on their side of the body where the antenna is located.

In another embodiment, there are eight antennas, four antennas located in each pillar. There are two antennas located on each front face as the subject approaches the system. This would allow the officer to carry the weapon with less requirements around the SOP.

In another embodiment, there is a single antenna located on the inside face of a pillar at the midriff.

In another embodiment, there are two antennas located on the inside face of one pillar: one located at shoulder height and one at knee height.

In another embodiment, there are two antennas used and positioned on the inside face of each pillar in the midriff area.

In another embodiment, there are four antennas used, with two antennas on each of the inside faces, positioned at shoulder and knee height.

Disclosed herein is a gateway screening system enabling personnel to pass through without setting off an alarm. The gateway screening system comprises a processor, a security system, a wireless module that integrates with the security system, a RFID card reader that scans a wireless tag of a weapon and ID of the personnel, a database storing records of credentials and activity of the personnel and an alarm module integrated with the security system. The alarm is triggered during a credentials check whereby there is no match in records and the alarm is not triggered if there is a record match. The RFID reader is set to continuous read mode to detect nearby tags operating at UHF (Ultra High Frequency).

In a further embodiment, a method of screening personnel using a gateway security system is disclosed. The method comprises the steps of setting a RFID reader to continuous read mode to continuously detect nearby operating tags using a wireless module that integrates with the security system, scanning the ID of a personnel and the wireless tag of a personnel weapon, comparing the tag ID of the personnel and the weapon with entries stored on a database. In the case both weapon tag and personnel tag ID match with database entry, override the alarm at the gateway security system and in the case both weapon tag and personnel tag ID do not match with database entry, trigger an alarm at the gateway security system.

Implementations disclosed herein provide systems, methods and apparatus for generating or augmenting training data sets for machine learning training. The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

1. A gateway screening system enabling personnel to pass through without setting off an alarm comprising:
a processor;
a security system;
a wireless module that integrates with the security system;
a RFID card reader that scans a wireless tag of a weapon and ID of the personnel;
a database storing records of credentials and activity of the personnel; and
an alarm module integrated with the security system;
wherein an alarm is triggered during a credentials check whereby there is no match in records and the alarm is not triggered if there is a record match;
wherein the RFID reader is set to continuous read mode to detect nearby tags operating at UHF (Ultra High Frequency).

2. The system of claim 1 wherein the personnel is a security guard or user of the system.

3. The system of claim 1 wherein the wireless module is selected from a list consisting of RFID, NFC®, Bluetooth® or cellular connectivity.

4. The system of claim 1 wherein the wireless module supports a UHF antenna.

5. The system of claim 1 wherein the database is stored locally on a server or on a cloud server.

6. The system of claim 1 wherein the ID of the personnel is an ID fob, ID card, dongle or mobile application.

7. A method of screening personnel using a gateway security system the method comprising the steps of:
setting a RFID reader to continuous read mode to continuously detect nearby operating tags using a wireless module that integrates with the security system;
scanning the ID of a personnel and the wireless tag of a personnel weapon;
comparing the tag ID of the personnel and the weapon with entries stored on a database;
in the case both weapon tag and personnel tag ID match with database entry, override the alarm at the gateway security system; and
in the case both weapon tag and personnel tag ID do not match with database entry, trigger an alarm at the gateway security system.

8. The method of claim 7 wherein the RFID reader operates continuously at UHF (Ultra High Frequency).

9. The system of claim 7 wherein the personnel is a security guard or user of the system.

10. The system of claim 7 wherein the wireless module is selected from a list consisting of RFID®, NFC®, Bluetooth® or cellular connectivity.

11. The system of claim 7 wherein the wireless module supports a UHF antenna.

12. The system of claim 7 wherein the database is stored locally on a server or on a cloud server.

13. The system of claim 7 wherein the ID of the personnel is an ID fob, ID card, dongle or mobile application.
